(19) United States
(12) Patent Application Publication
(10) Pub. No.: US 2019/0193443 A1
(43) Pub. Date: Jun. 27, 2019

(54) METHOD AND APPARATUS FOR PRINTING

(71) Applicant: Datamax-O'Neil Corporation, Orlando, FL (US)

(72) Inventors: Chin Young Wong, Singapore (SG); Yaw Horng Yap, Singapore (SG); Ching Hong Chua, Singapore (SG)

(21) Appl. No.: 15/854,875

(22) Filed: Dec. 27, 2017

(51) Int. Cl. B41J 32/00; B41J 29/02; B41J 3/36

(52) U.S. Cl. CPC B41J 32/00; B41J 3/36; B41J 29/02

(57) ABSTRACT

The present invention embraces printers such as hand-held printers and mobile/portable printer. One exemplary embodiment includes “print as you glide” (PAYG) devices. Such printers may comprise a modular print engine that is removable from the printer and may allow a user to easily access and load the ribbon in the mobile print engine. The modular print engine may comprise a modular print head and an encoder that may determine the movement of the print head relative to a stationary media. When a printer is pressed against the media, the print head's burn line may be resting on the media. When the printer is stationary relative to the media, the encoder may not trigger the printing. Once PAYG is being slid or glided across the media, the encoder may start to rotate and then send a signal to a processor, causing the printer to start printing.

### FIELD OF THE INVENTION

The present invention relates to improvements in printers, and more particularly, for apparatus and methods for a hand-held printer.

### BACKGROUND

Generally speaking, a legacy printer is a stationary device comprising a printer mechanism. Instructions and content are input to the legacy printer causing the legacy printer to print the content on media, such as a label. This legacy printer design lacks flexibility, especially when a mobile printer environment is desired.

Therefore, a need exists for apparatuses and methods for portable or mobile printer architectures and mechanisms.

### SUMMARY

Accordingly, in one aspect, the present invention embraces printers such as hand-held printers and mobile/portable printers. One exemplary embodiment includes “print as you glide” (PAYG) devices. Such printers may comprise a modular print engine that is removable from the printer and may allow a user to easily access and load the ribbon in the mobile print engine.

In an exemplary embodiment, a device comprises: a modular print engine comprising a modular print head and a media encoder; a printed circuit board (PCB) comprising a processor; and a main body comprising the modular print engine and the printed circuit board. The modular print engine is removable from the main body to allow a user to load a new ribbon in the modular print engine. When the modular print engine and a media are in contact and there is movement between the modular print engine and the media, the modular print engine prints on the media.

When the device presses against the media, a burn line of the modular print head presses a ribbon against the media. In response to the device starting to slide across to the media, the media encoder sends a signal to the processor with an instruction to start a print operation. The media encoder generates the signal based on a rotation in the media encoder caused by the device sliding across the media. The modular print engine comprises a rotating arm with a spring mechanism, associated with the media encoder. Based on a direction of rotation of the media encoder, the modular print engine either stops printing, or continues printing. The main body comprises a battery. The modular print head is removable from the modular print engine. The device comprises a fine needle opening located at one end of the device, wherein, when an adapter plug is inserted in the fine needle opening, silicon rubber of the adapter plug conforms to a shape of the adapter plug and creates a seamless water proofing seal between the adapter plug and the device.

In another exemplary embodiment, a method comprising the steps of: opening, by a user, a cover from a main body of a printer; removing, by the user, a modular print engine from a casing of the main body; loading, by the user, a ribbon roll in the modular print engine; inserting, by the user, the modular print engine in the casing of the main body; and closing, by the user, the cover on the main body. Loading the ribbon roll in the modular print engine comprises installing a new ribbon on a ribbon supply shaft, and removing an old ribbon from a ribbon rewind shaft. A media encoder determines if the modular print engine is depleted of ribbon.

In yet another exemplary embodiment, a method comprise the steps of: removing, by a user, a modular print engine from a main body of a printer; loading, by the user, a ribbon roll into the modular print engine; re-installing, by the user, the modular print engine in the main body of the printer positioning and pressing, by the user, a print head and a media encoder of the modular print engine on a media located on a horizontal surface; and sliding, by the user, the print head across the media causing the media encoder to sense a movement of the media relative to the print head and send a signal to a processor of the printer. The processor sends an instruction to the print head to begin a print operation.

If the user continues to slide the print head across the media, the print head continues the print operation. If the user does not continue to slide the print head across the media, the processor sends another instruction to the print head to stop the print operation. Removing the modular print engine from the main body of the printer comprises the user removing a cover from the modular print engine and removing the modular print engine from a casing of the main body of the printer. When the print head presses against the media, a burn line of the print head presses ribbon against the media. The media encoder pulls ribbon pass a burn line as the printer slides across the media. The print head is removable from the modular print engine.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1A provides a cross-sectional view of an exemplary embodiment of the components of a printer.

FIG. 1B provides a cross-sectional view of an exemplary embodiment of a portion of the operation of a printer.

FIG. 1C provides a cross-sectional view of an exemplary embodiment of another portion of the operation of a printer.

FIG. 2A illustrates an exemplary embodiment of a printer.

FIG. 2B illustrates an exemplary embodiment of an exploded view of a printer.

FIG. 2C illustrates an exemplary embodiment of a print engine of a printer and its positioning in the printer.

FIG. 2D illustrates an exemplary embodiment of a subsystem of a modular print engine assembly of a printer.

FIG. 2E illustrates an exemplary embodiment the process of loading a ribbon in a printer.

FIG. 2F illustrates an exemplary embodiment of the process of installing a modular print engine into the main body of a printer.

FIG. 2G illustrates an exemplary embodiment of two views of modular print engine that identifies the media encoder and ribbon encoder.

FIG. 2H illustrates an exemplary embodiment of a view of main body including media encoder, ribbon roll and media.

FIG. 2I illustrates an exemplary embodiment of modular print engine assembly including ribbon rewind shaft comprising gear teeth at one end of the ribbon rewind shaft.

FIG. 2J illustrates an exemplary embodiment of a close-up view of ribbon roll and modular print engine.

FIG. 2K illustrates an exemplary embodiment of printer sliding relative to media with two orientations.

FIG. 2L illustrates an exemplary embodiment of the media encoder generating the signal based on a rotation in the media encoder caused by the printer sliding across the media.

FIG. 3 illustrates an exemplary flowchart for a process to access the print head of a printer.

FIG. 4 illustrates an exemplary flowchart for a process to print with a printer.

### DETAILED DESCRIPTION

The present invention embraces printers such as mobile, portable or hand-held printers. One exemplary embodiment includes “print as you glide” (PAYG) devices. A printer based on the present invention may comprise a modular print engine that is removable from the printer and may allow a user to easily access and load the ribbon in the modular print engine. The modular print engine may comprise a modular print head and a media encoder that may determine the movement of the print head relative to a stationary media. When a printer is pressed against the media, the print head's burn line may be resting on the media. When the printer is stationary relative to the media, the media encoder may not trigger the printing. Once a PAYG device begins to slide or glide across the media, the media encoder may start to rotate and then may send a signal to a processor, causing the printer to start printing. One skilled in the art may recognize that the terms “stationary media” means that the media, e.g., a label, is stationary relative to the modular print engine. In another embodiment, the modular print engine may be stationary, and the media moves relative to the modular print engine. For either embodiment, the print operation may start when there is relative movement between the modular print engine and the media.

The modular print engine may include a ribbon encoder that may determine if the modular print engine is depleted of ribbon. The modular print head may removable from the modular print engine.

To support battery charging or direct powering of the printer, a very fine needle opening is present on the main body of the printer for an adapter plug. Upon insertion of the adapter plug, the silicon rubber, with its stretchable ability, conforms the shape of the adapter plug and creates a seamless water proofing seal between the adapter plug and the printer. Effectively, the silicon rubber is part of the housing of the printer. When the adapter plug is inserted into the housing, the silicon rubber may stretch itself to confirm to the shape of the mating part.

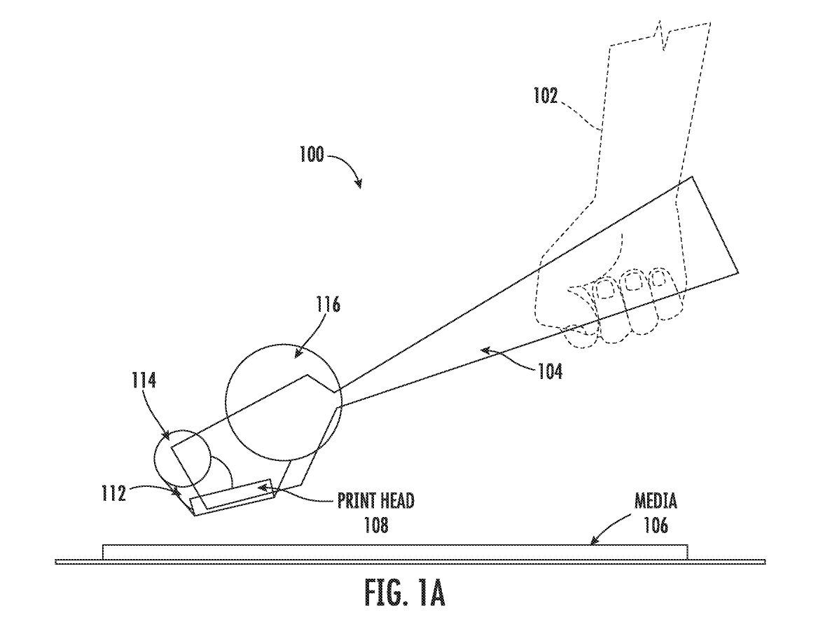

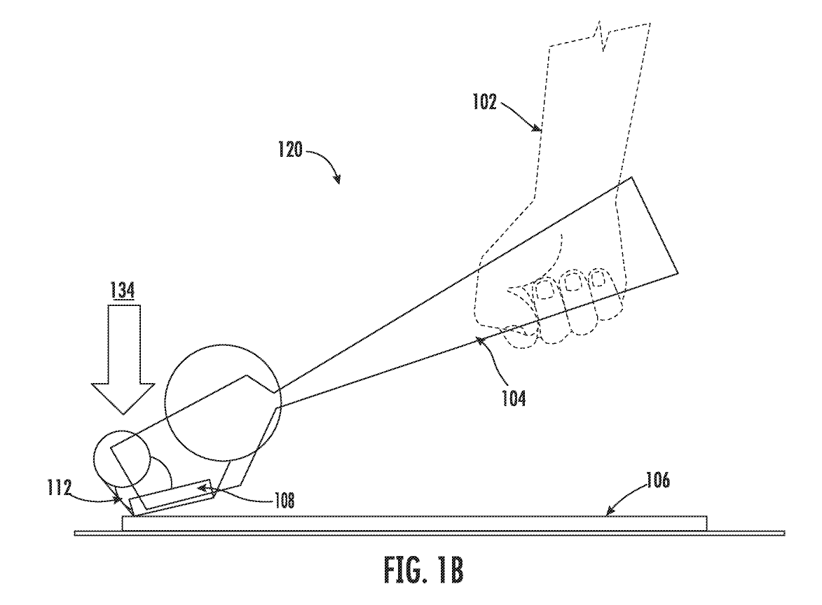

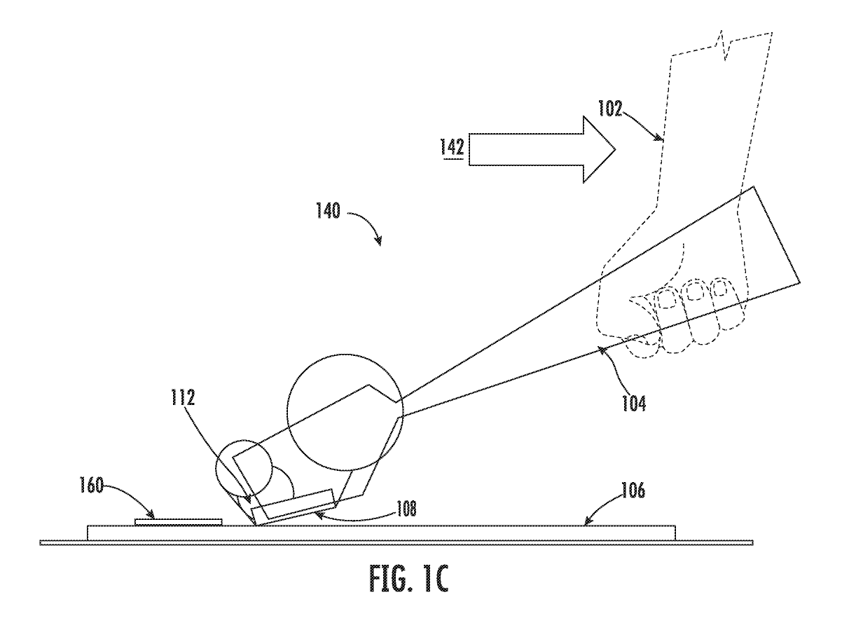

FIG. 1A provides a cross-sectional view of an exemplary embodiment of the components of printer 100. Printer 100 may be a PAYG device. As shown, handle 104 of printer 100 may be configured to provide a removable engagement with user 102. In one embodiment, the user 102 may pick-up handle 104 and hold printer 100 in their hand, per FIG. 1A.

Printer 100 may further comprise ribbon supply shaft 116 and ribbon rewind shaft 114. The ribbon supply shaft 116 may comprise a roll of ribbon such as a new ribbon, and the ribbon rewind shaft 114 may include old or used ribbon. Printing may be facilitated with print head 108 and media encoder 112. Print head 108 may be a near edge print head. Located on a horizontal surface may be the media 106. As illustrated in FIG. 1A, media 106 may be a pasted label Media encoder 112 may determine the movement of print head 108 relative to media 106.

FIG. 1B provides a cross-sectional view of an exemplary embodiment of a portion of the operation of printer 120. As shown, user 102 may engage with and hold handle 104 of printer 120. User 102 may proceed to press down the print head 108 and media encoder 112 with force 134. When printer 120 is pressed against media 106, print head 108's burn line is resting on media 106. If printer 120 is stationary, media encoder 112 may not trigger the printing.

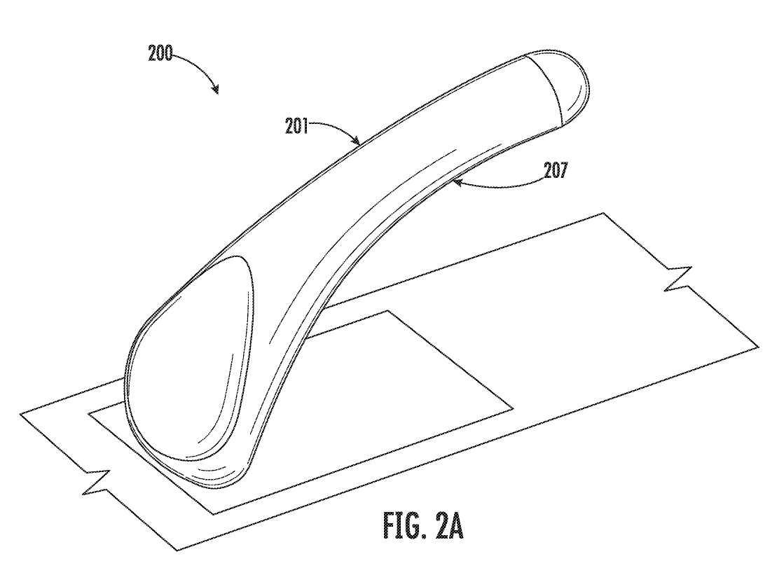

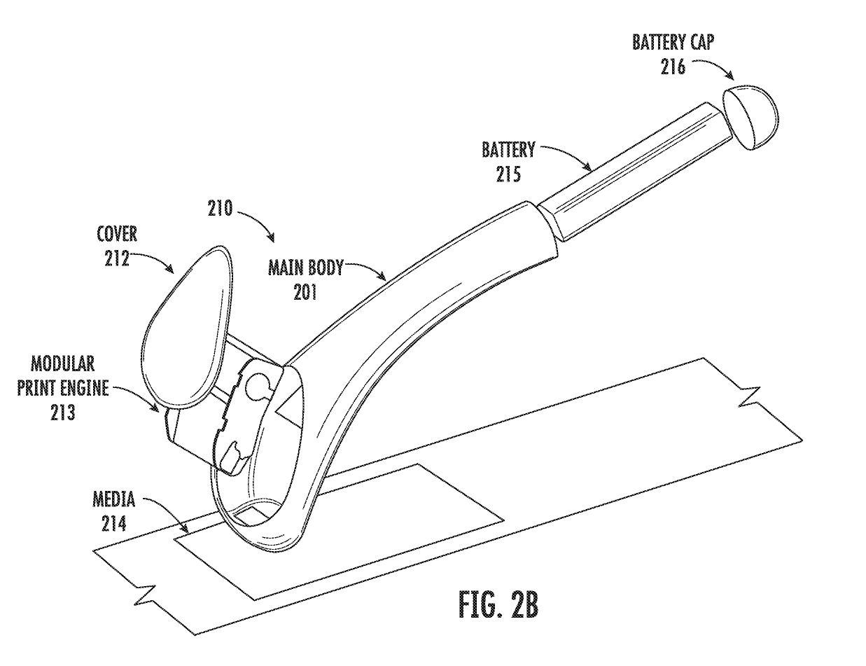

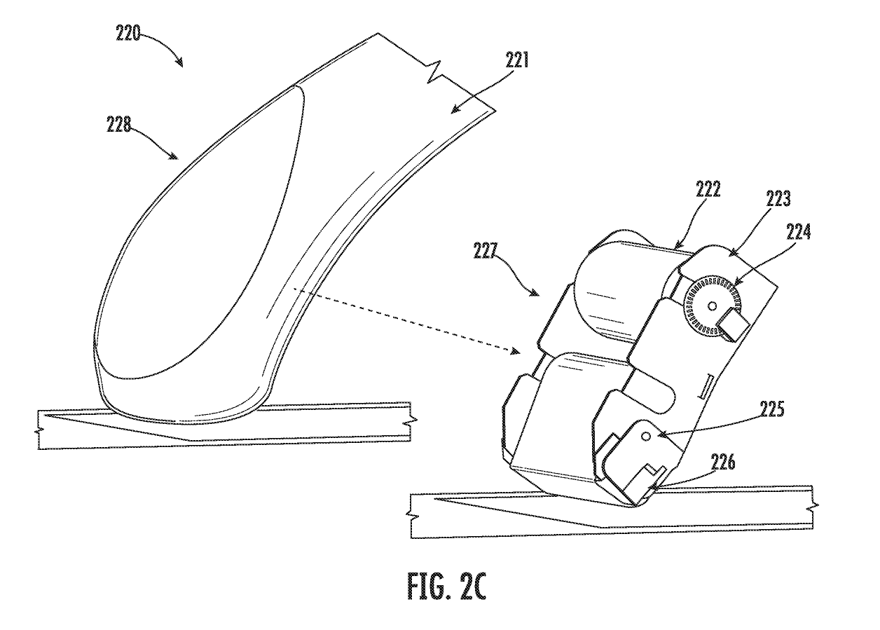

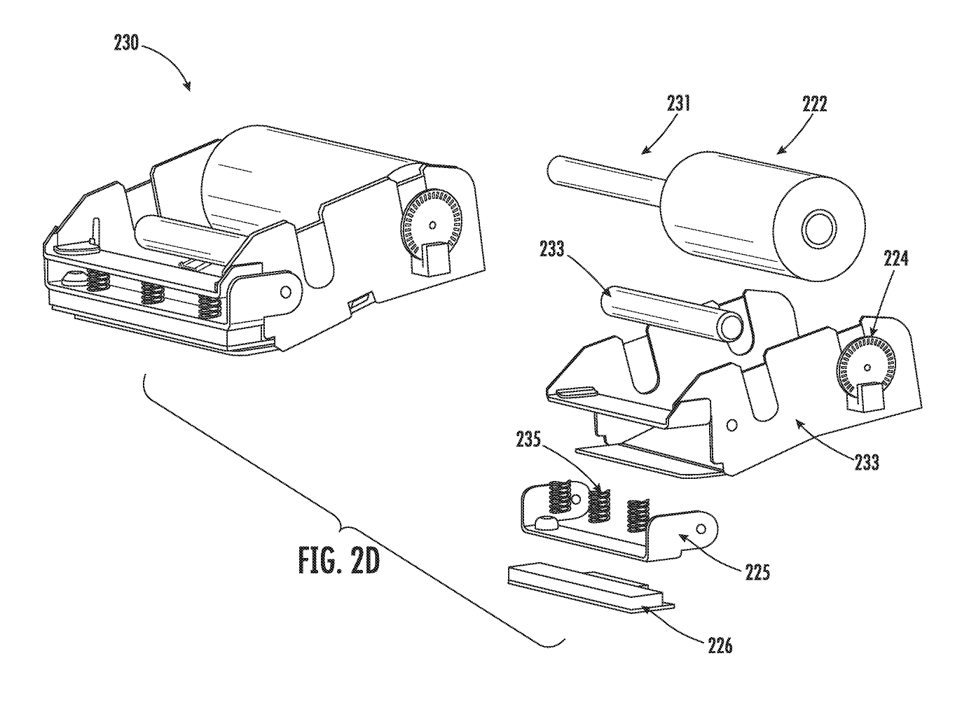

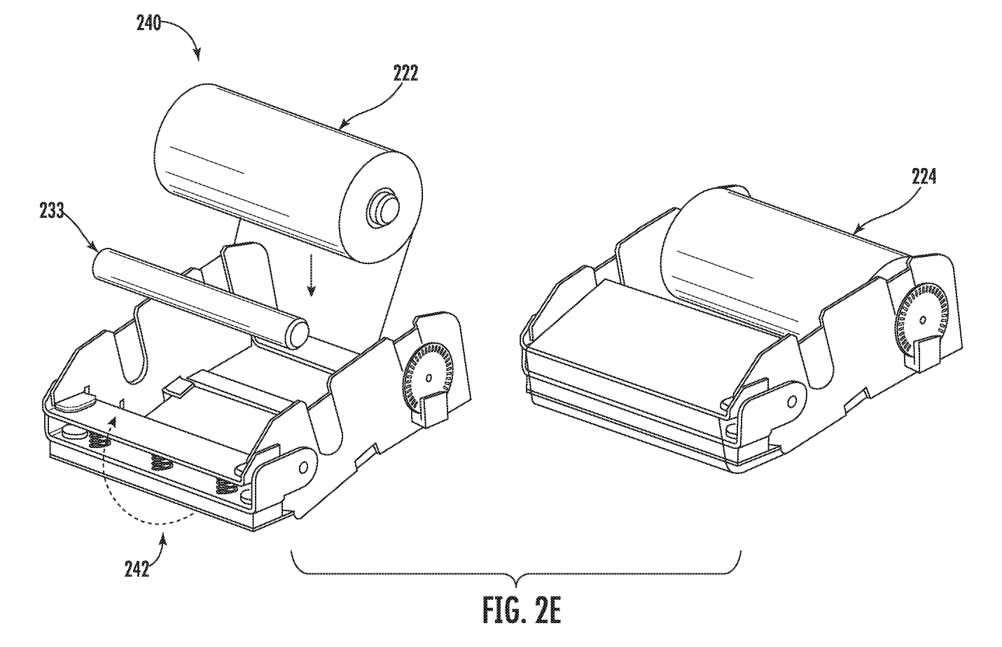

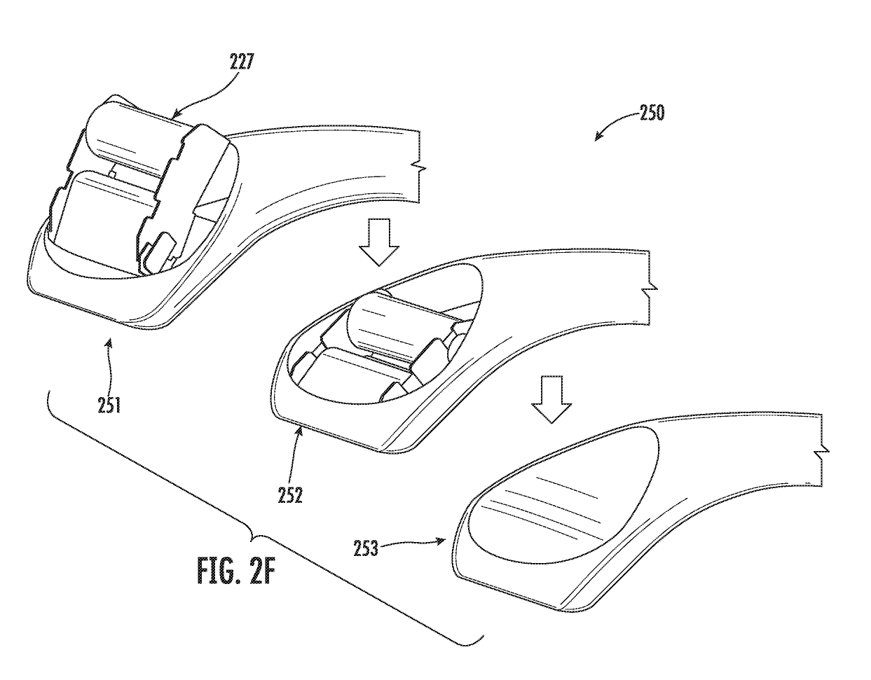

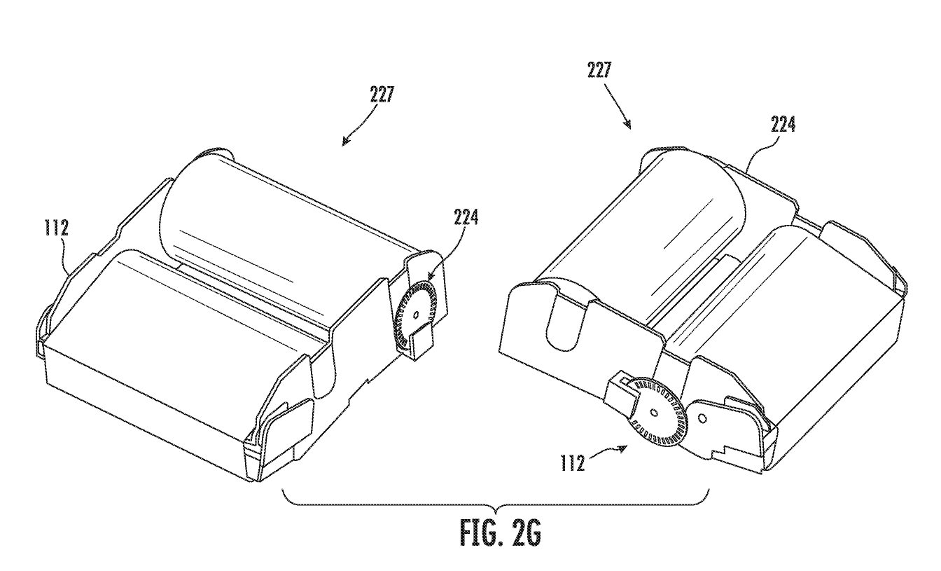

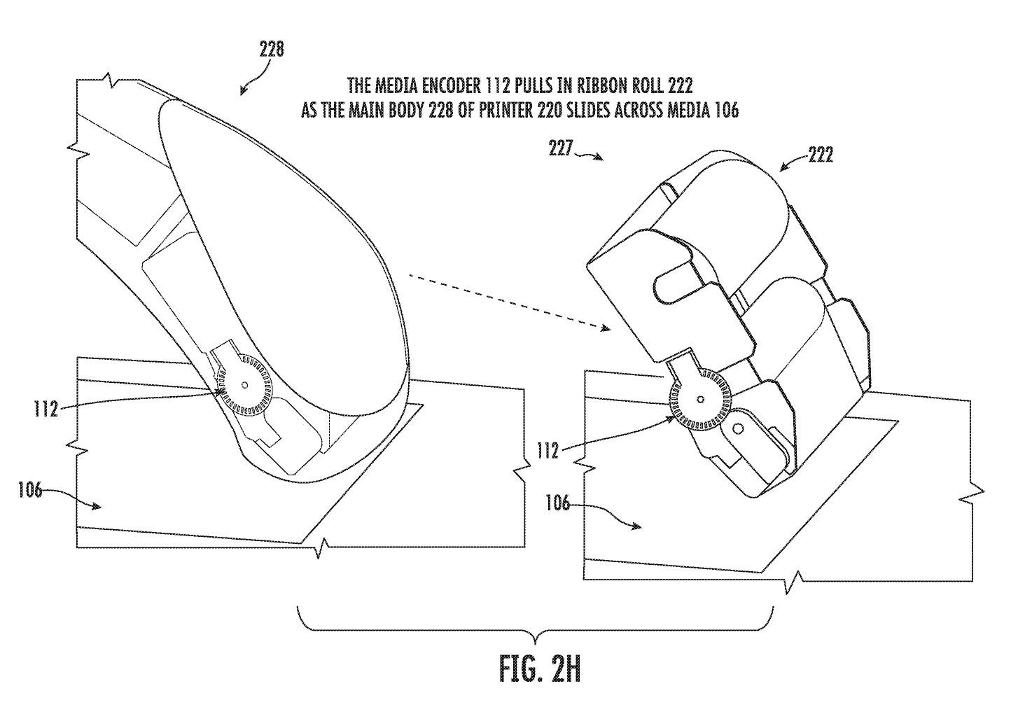

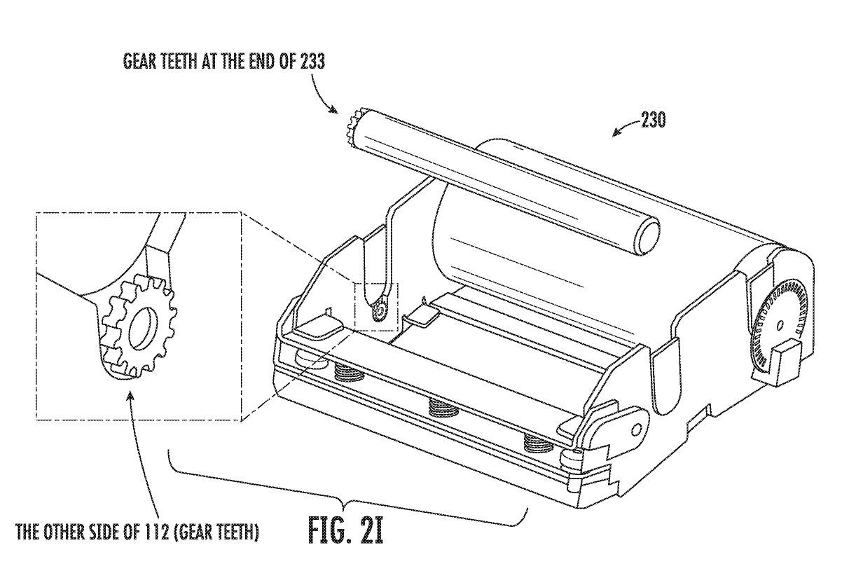

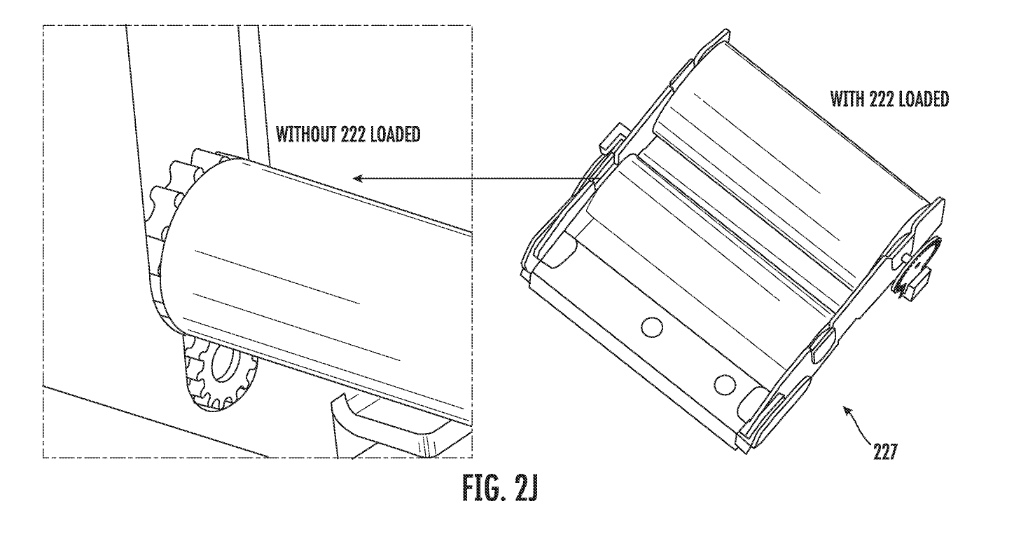

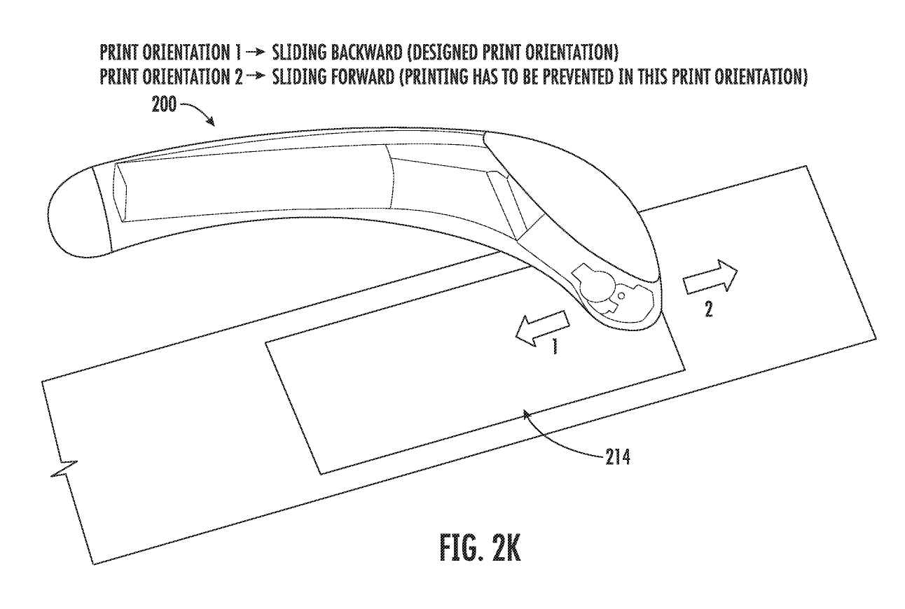

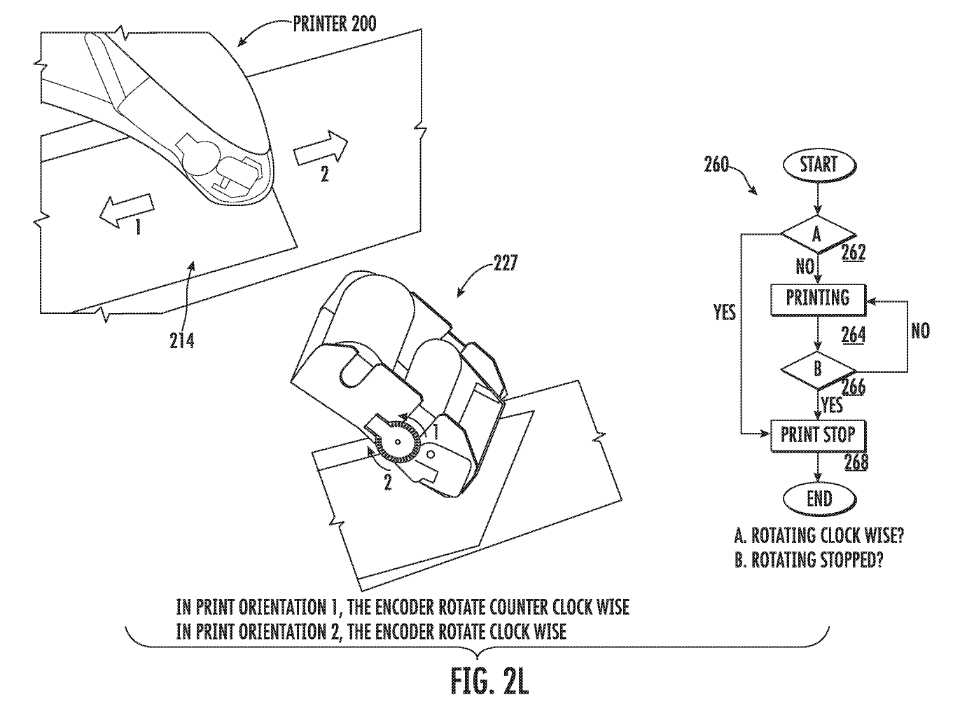

FIG. 1C provides a cross-sectional view of an exemplary embodiment of another portion of the operation of a printer 140. As shown, user 102, while engaged with handle 104, may pull printer 140 across media 106 with force 142. Concurrently, media encoder 112 may rotate and may start to fire print head 108. Subsequently, ink 160, wax or other material suitable for thermal transfer may be deposited on media 106. Hence, once printer 140 starts to slide (or glide), media encoder 112 may start to rotate and send a signal to a processor of printer 140, causing a print operation to start. The media encoder 112 pulls in loose ribbon as the printer slides across the media 106. The specifics of this action are described herein in FIGS. 2G, 2H, 2I and 2J.

FIG. 2A illustrates an exemplary embodiment of printer 200. Printer 200 is shown in a physical position as the PAYG device may be normally used in a print operation. Printer 200 may comprise a main body 201. Main body 201 provides the functionality for handle 104 of FIG. 1A, FIG. 1B, and FIG. 1C. In one embodiment, main body 201 may be designed with a single span surface where the surface is smooth. The main body 201 may also comprise a handle area 207 having a rubber surface. Handle area 207 is located on the bottom portion of main body 201. The rubber surface may comprise a silicon material. The rubber surface may assist in improving the engagement of the grip of user 102 on printer 200.

FIG. 2B illustrates an exemplary embodiment of an exploded view of a printer 210. Printer 210 may comprise main body 201, cover 212, modular print engine 213, battery 215 and battery cap 216. Printer 210 may be positioned proximate to media 214 that may be positioned on a horizontal surface.

FIG. 2C illustrates an exemplary embodiment of a modular print engine 227 of printer 220 and is positioning in the main body 228 of printer 220. As shown, modular print engine 227 may be positioned in a lower portion of the main body 228. Located in the upper portion of the main body may be a printed circuit board (PCB) 221 which may contain logic, circuitry, and a processor for printer operation. Modular print engine 227 may comprise ribbon roll 222, engine holder 223, ribbon encoder 224, rotating arm 225, and a modular print head 226. Ribbon encoder 224 may determine if ribbon roll 222 is depleted of ribbon.

FIG. 2D illustrates an exemplary embodiment of a subsystem of a modular print engine assembly 230 for printer 200. Modular print engine assembly 230 may comprise ribbon supply shaft 231, ribbon roll 222, ribbon rewind shaft 233, engine holder 223, a spring mechanism 235, rotating arm 225, a modular print head 226 and a ribbon encoder 224. Note that FIG. 2C and FIG. 2D have some equivalent elements.

The modular print head 226 may be a replaceable component. Ribbon encoder 224 may determine if the roll of ribbon on ribbon supply shaft 231 is depleted of ribbon. In this case may be appropriate for a new ribbon to be loaded in the modular print engine. The other encoder, equivalent to media encoder 112 of FIG. 1A, may be located on the other side of rotating arm 225, but is not shown on FIG. 2D.

Pressing down on modular print head 226 may cause a swivel of rotating arm 225. When modular print head 226 is slid across media 214, as illustrated in FIG. 2B, the media encoder senses a movement of the media relative to the print head and sends a signal to a processor of the printer. In one exemplary embodiment, a wheel associated with media encoder 112, as illustrated in FIGS. 1A, 1B and 1C, rotates and causes a signal to be generated. The signal, with instructions to begin a print operation, is coupled to a processor of the printer. Rotating arm 225 further comprises spring mechanism 235.

FIG. 2E illustrates an exemplary embodiment the process of loading a ribbon in a modular print engine assembly 240. As shown, ribbon roll 222 may be engaged or installed in the modular print engine assembly 240, as indicated by the downward arrow. Ribbon rewind shaft 233 may be available to support the old or used ribbon. Dotted line 242 indicates the rotation of rotating arm 225. Ribbon may be easily installed in modular print engine assembly 240 to provide an assembled modular print engine 244. In other words, the modular print engine is removed by the user from the main body of the device by (i) removing a cover of the main body, and (ii) picking up the modular print engine from a casing of the main body. With the removal of the modular print engine from the main body, the user loads the new ribbon on a ribbon supply shaft and removes an old ribbon from a ribbon unwind shaft.

FIG. 2F illustrates an exemplary embodiment of the process 250 of the installing modular print engine 227 into the printer 200. As shown, modular print engine 227 may begin to be inserted in in main body 251. In main body 252, the insertion of modular print engine 227 may be completed. Finally, in main body 253, a cover is placed on main body 253 to protect and secure the modular print engine 227 in printer 200.

The media encoder 112 pulls in loose ribbon as the printer slides across the media 106. In other words, the media encoder pulls ribbon pass a burn line as the printer slides across the media This action is illustrated in FIG. 2G and FIG. 2H. FIG. 2G illustrates an exemplary embodiment of two views of modular print engine 227 that identifies the media encoder 112 and ribbon encoder 224. FIG. 2H illustrates an exemplary embodiment of a view of main body 228 including media encoder 112 and media 106. FIG. 2H also illustrates an exemplary embodiment of another view of modular print engine 227 including ribbon roll 222, media encoder 112 and media 106. The media encoder 112 pulls in ribbon roll 222 as the main body 228 (printer) slides across the media 106. FIG. 2I and FIG. 2J illustrate the action to pull in loose ribbon as the printer slides across the media 106. FIG. 2I illustrates an exemplary embodiment of modular print engine assembly 230 including ribbon rewind shaft 233 comprising gear teeth at one end of the ribbon rewind shaft 233. Also illustrated are the gear teeth on the other side of the media encoder 112. FIG. 2J illustrates an exemplary embodiment of a close-up view of ribbon roll 222 that is not load in modular print engine assembly 240 (not shown) and ribbon roll 222 loaded in modular print engine 227. The media encoder 112 pulls in loose ribbon as the printer slides across the media 106 utilizing the gear structure illustrated in FIG. 2I and FIG. 2J.

FIG. 2K illustrates an exemplary embodiment of printer 200 sliding relative to media 214 with two orientations. With print orientation 1, the printer 200 is sliding backward relative to media 214. Print orientation 1 is the designed print orientation mode. With print orientation 2, the printer 200 is sliding forward relative to the media 214. Printing must be prevented with print orientation 2.

Detection control may be utilized to prevent an incorrect orientation for printing. When firmware detects encoder rotation in the wrong direction, printing may stop. FIG. 2L illustrates an exemplary embodiment of the media encoder 112 generating the signal based on a rotation in the media encoder 112 caused by the printer 200 sliding across the media 106. With print orientation 1, media encoder 112 rotates counter clockwise. In print orientation 2, media encoder 112 rotates clockwise. FIG. 2L also includes a flowchart 260 describing the method for initiating and stopping printing. The method includes the following steps:

Does the encoder rotate clockwise? (A) (step 262)

If yes, stop printing. (step 268)

If no, initiate printing. (step 264)

Is the rotating stop? (B) (step 266)

If no, continue printing at step 264.

If yes, stop printing at step 268.

As used herein, media 106 and media 214 may be considered equivalent.

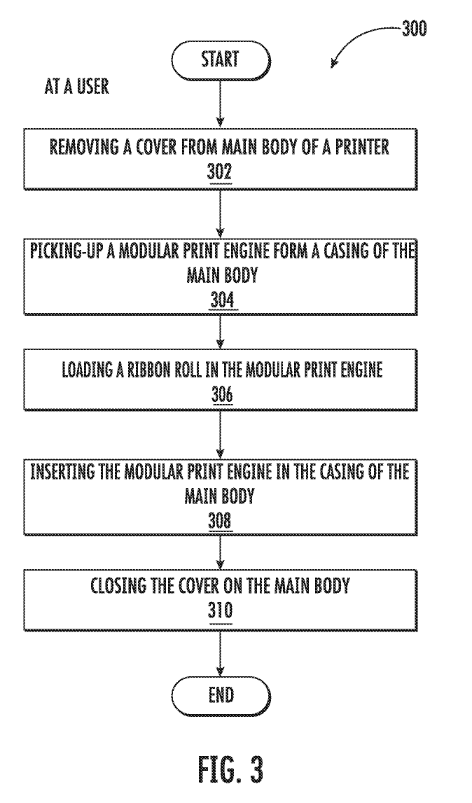

FIG. 3 illustrates an exemplary flowchart for a process 300 to access the print head of a printer. The process 300 comprises the following steps by a user:

Removing a cover from the main body of a printer. (step 302)

Picking-up the modular print engine from a casing of the main body. (step 304)

Loading a ribbon roll in the modular print engine (step 306)

Inserting the modular print engine in the casing of the main body (step 308)

Closing the cover on the main body. (step 310)

Loading the ribbon roll in the modular print engine comprises installing a new ribbon on a ribbon supply shaft, and removing an old ribbon from a ribbon rewind shaft. Closing the cover allows a print operation to begin.

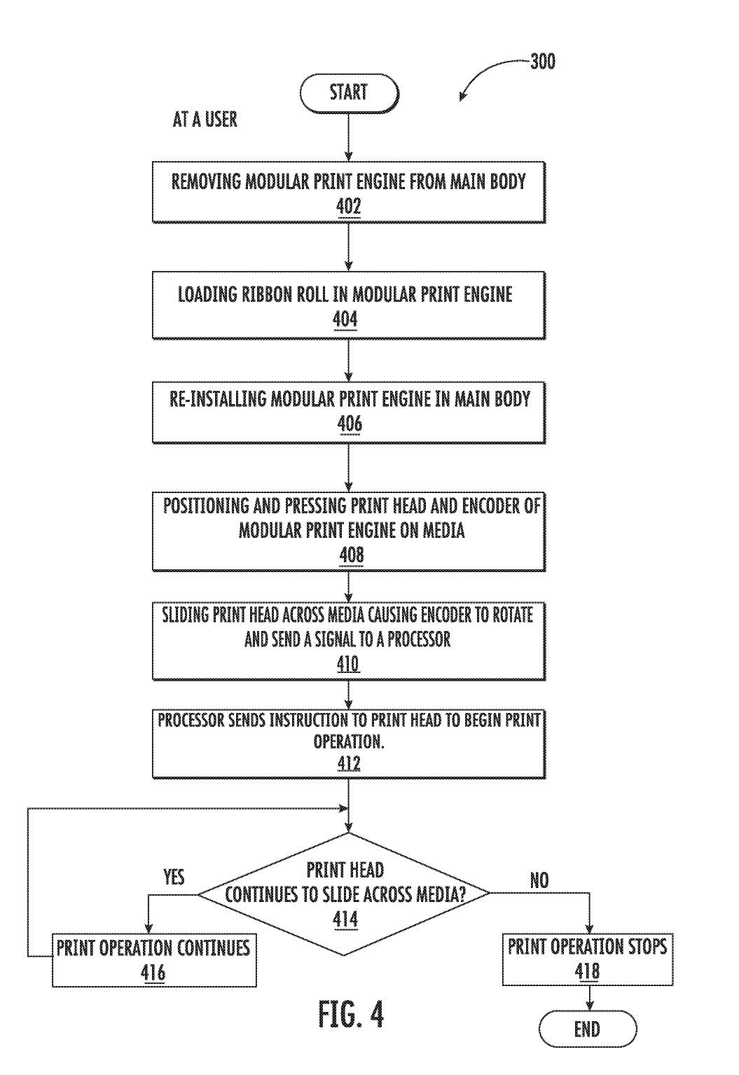

FIG. 4 illustrates an exemplary flowchart for a process 400 to print with a printer. The process 400 comprises the following steps by a user:

Removing a modular print engine from a main body of a printer. (step 402)

Loading a ribbon roll in the modular print engine. (step 404)

Re-installing the modular print engine in the main body of the printer. (step 406)

Positioning and pressing a print head and an encoder of the modular print engine on a media located on a horizontal surface. (step 408)

Sliding the print head across the media causing the encoder to rotate and send a signal to a processor of the printer. (step 410)

The processor sends an instruction to the print head to begin a print operation. (step 412)

Does the print head continue to slide across the media? (step 414)

If the user continues to slide the print head across the media, the print head continues the print operation. (step 416)

If the user does not continue to slide the print head across the media, the processor sends an instruction to the print head to stop the print operation. (step 418)

To supplement the present disclosure, this application incorporates entirely by reference the following commonly assigned patents, patent application publications, and patent applications:

U.S. Pat. Nos. 6,832,725; 7,128,266;
7,159,783; 7,413,127;
7,726,575; 8,294,969;
8,317,105; 8,322,622;
8,366,005; 8,371,507;
8,376,233; 8,381,979;
8,390,909; 8,408,464;
8,408,468; 8,408,469;
8,424,768; 8,448,863;
8,457,013; 8,459,557;
8,469,272; 8,474,712;
8,479,992; 8,490,877;
8,517,271; 8,523,076;
8,528,818; 8,544,737;
8,548,242; 8,548,420;
8,550,335; 8,550,354;
8,550,357; 8,556,174;
8,556,176; 8,556,177;
8,559,767; 8,599,957;
8,561,895; 8,561,903;
8,561,905; 8,565,107;
8,571,307; 8,579,200;
8,583,924; 8,584,945;
8,587,595; 8,587,697;
8,588,869; 8,590,789;
8,596,539; 8,596,542;
8,596,543; 8,599,271;
8,599,957; 8,600,158;
8,600,167; 8,602,309;
8,608,053; 8,608,071;
8,611,309; 8,615,487;
8,616,454; 8,621,123;
8,622,303; 8,628,013;
8,628,015; 8,628,016;
8,629,926; 8,630,491;
8,635,309; 8,636,200;
8,636,212; 8,636,215;
8,636,224; 8,638,806;
8,640,958; 8,640,960;
8,643,717; 8,646,692;
8,646,694; 8,657,200;
8,659,397; 8,668,149;
8,678,285; 8,678,286;
8,682,077; 8,687,282;
8,692,927; 8,695,880;
8,698,949; 8,717,494;
8,717,494; 8,720,783;
8,723,804; 8,723,904;
8,727,223; 8,740,082;
8,740,085; 8,746,563;
8,750,445; 8,752,766;
8,756,059; 8,757,495;
8,760,563; 8,763,909;
8,777,108; 8,777,109;
8,779,898; 8,781,520;
8,783,573; 8,789,757;
8,789,758; 8,789,759;
8,794,520; 8,794,522;
8,794,525; 8,794,526;
8,798,367; 8,807,431;
8,807,432; 8,820,630;
8,822,848; 8,824,692;
8,824,696; 8,842,849;
8,844,822; 8,844,823;
8,849,019; 8,851,383;
8,854,633; 8,866,963;
8,868,421; 8,868,519;
8,868,802; 8,868,803;
8,870,074; 8,879,639;
8,880,426; 8,881,983;
8,881,987; 8,903,172;
8,908,995; 8,910,870;
8,910,875; 8,914,290;
8,914,788; 8,915,439;
8,915,444; 8,916,789;
8,918,250; 8,918,564;
8,925,818; 8,939,374;
8,942,480; 8,944,313;
8,944,327; 8,944,332;
8,950,678; 8,967,468;
8,971,346; 8,976,030;
8,976,368; 8,978,981;
8,978,983; 8,978,984;
8,985,456; 8,985,457;
8,985,459; 8,985,461;
8,988,578; 8,988,590;
8,991,704; 8,996,194;
8,996,384; 9,002,641;
9,007,368; 9,010,641;
9,015,513; 9,016,576;
9,022,288; 9,030,964;
9,033,240; 9,033,242;
9,036,054; 9,037,344;
9,038,911; 9,038,915;
9,047,098; 9,047,359;
9,047,420; 9,047,525;
9,047,531; 9,053,055;
9,053,378; 9,053,380;
9,058,526; 9,064,165;
9,064,165; 9,064,167;
9,064,168; 9,064,254;
9,066,032; 9,070,032;
9,076,459; 9,079,423;
9,080,856; 9,082,023;
9,082,031; 9,084,032;
9,087,250; 9,092,681;
9,092,682; 9,092,683;
9,093,141; 9,098,763;
9,104,929; 9,104,934;
9,107,484; 9,111,159;
9,111,166; 9,135,483;
9,137,009; 9,141,839;
9,147,096; 9,148,474;
9,158,000; 9,158,340;
9,158,953; 9,159,059;
9,165,174; 9,171,543;
9,183,425; 9,189,669;
9,195,844; 9,202,458;
9,208,366; 9,208,367;
9,219,836; 9,224,024;
9,224,027; 9,230,140;
9,235,553; 9,239,950;
9,245,492; 9,248,640;
9,250,652; 9,250,712;
9,251,411; 9,258,033;
9,262,633; 9,262,660;
9,262,662; 9,269,036;
9,270,782; 9,274,812;
9,275,388; 9,277,668;
9,280,693; 9,286,496;
9,298,964; 9,301,427;
9,313,377; 9,317,037;
9,319,548; 9,342,723;
9,361,882; 9,365,381;
9,373,018; 9,375,945;
9,378,403; 9,383,848;
9,384,374; 9,390,304;
9,390,596; 9,411,386;
9,412,242; 9,418,269;
9,418,270; 9,465,967;
9,423,318; 9,424,454;
9,436,860; 9,443,123;
9,443,222; 9,454,689;
9,464,885; 9,465,967;
9,478,983; 9,481,186;
9,487,113; 9,488,986;
9,489,782; 9,490,540;
9,491,729; 9,497,092;
9,507,974; 9,519,814;
9,521,331; 9,530,038;
9,572,901; 9,558,386;
9,606,581; 9,646,189;
9,646,191; 9,652,648;
9,652,653; 9,656,487;
9,659,198; 9,680,282;
9,697,401; 9,701,140;
U.S. Design Pat. No. D702,237;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D734,339;
U.S. Design Pat. No. D737,321;
U.S. Design Pat. No. D754,205;
U.S. Design Pat. No. D754,206;
U.S. Design Pat. No. D757,009;
U.S. Design Pat. No. D760,719;
U.S. Design Pat. No. D762,604;
U.S. Design Pat. No. D766,244;
U.S. Design Pat. No. D777,166;
U.S. Design Pat. No. D771,631;
U.S. Design Pat. No. D783,601;
U.S. Design Pat. No. D785,617;
U.S. Design Pat. No. D785,636;
U.S. Design Pat. No. D790,505;
U.S. Design Pat. No. D790,546;

### International Publication No. 2013/163789;

### U.S. Patent Application Publication No. 2008/0185432;

### U.S. Patent Application Publication No. 2009/0134221;

### U.S. Patent Application Publication No. 2010/0177080;

### U.S. Patent Application Publication No. 2010/0177076;

### U.S. Patent Application Publication No. 2010/0177707;

### U.S. Patent Application Publication No. 2010/0177749;

### U.S. Patent Application Publication No. 2010/0265880;

### U.S. Patent Application Publication No. 2011/0202554;

### U.S. Patent Application Publication No. 2012/0111946;

### U.S. Patent Application Publication No. 2012/0168511;

### U.S. Patent Application Publication No. 2012/0168512;

### U.S. Patent Application Publication No. 2012/0193423;

### U.S. Patent Application Publication No. 2012/0194692;

### U.S. Patent Application Publication No. 2012/0203647;

### U.S. Patent Application Publication No. 2012/0223141;

### U.S. Patent Application Publication No. 2012/0228382;

### U.S. Patent Application Publication No. 2012/0248188;

### U.S. Patent Application Publication No. 2013/0043312;

### U.S. Patent Application Publication No. 2013/0082104;

### U.S. Patent Application Publication No. 2013/0175341;

### U.S. Patent Application Publication No. 2013/0175343;

### U.S. Patent Application Publication No. 2013/0257744;

### U.S. Patent Application Publication No. 2013/0257759;

### U.S. Patent Application Publication No. 2013/0270346;

### U.S. Patent Application Publication No. 2013/0292475;

### U.S. Patent Application Publication No. 2013/0292477;

### U.S. Patent Application Publication No. 2013/0293539;

### U.S. Patent Application Publication No. 2013/0293540;

### U.S. Patent Application Publication No. 2013/0306728;

### U.S. Patent Application Publication No. 2013/0306731;

### U.S. Patent Application Publication No. 2013/0307964;

### U.S. Patent Application Publication No. 2013/0308625;

### U.S. Patent Application Publication No. 2013/0313324;

### U.S. Patent Application Publication No. 2013/0332996;

### U.S. Patent Application Publication No. 2014/0001267;

### U.S. Patent Application Publication No. 2014/0025584;

### U.S. Patent Application Publication No. 2014/0034734;

### U.S. Patent Application Publication No. 2014/0036848;

### U.S. Patent Application Publication No. 2014/0039693;

### U.S. Patent Application Publication No. 2014/0049120;

### U.S. Patent Application Publication No. 2014/0049635;

### U.S. Patent Application Publication No. 2014/0061306;

### U.S. Patent Application Publication No. 2014/0063289;

### U.S. Patent Application Publication No. 2014/0066136;

### U.S. Patent Application Publication No. 2014/0067692;

### U.S. Patent Application Publication No. 2014/0070005;

### U.S. Patent Application Publication No. 2014/0071840;

### U.S. Patent Application Publication No. 2014/0074746;

### U.S. Patent Application Publication No. 2014/0076974;

### U.S. Patent Application Publication No. 2014/0097249;

### U.S. Patent Application Publication No. 2014/0098792;

### U.S. Patent Application Publication No. 2014/0100813;

### U.S. Patent Application Publication No. 2014/0103115;

### U.S. Patent Application Publication No. 2014/0104413;

### U.S. Patent Application Publication No. 2014/0104414;

### U.S. Patent Application Publication No. 2014/0104416;

### U.S. Patent Application Publication No. 2014/0106725;

### U.S. Patent Application Publication No. 2014/0108010;

### U.S. Patent Application Publication No. 2014/0108402;

### U.S. Patent Application Publication No. 2014/0110485;

### U.S. Patent Application Publication No. 2014/0125853;

### U.S. Patent Application Publication No. 2014/0125999;

### U.S. Patent Application Publication No. 2014/0129378;

### U.S. Patent Application Publication No. 2014/0131443;

### U.S. Patent Application Publication No. 2014/0133379;

### U.S. Patent Application Publication No. 2014/0136208;

### U.S. Patent Application Publication No. 2014/0140585;

### U.S. Patent Application Publication No. 2014/0152882;

### U.S. Patent Application Publication No. 2014/0158770;

### U.S. Patent Application Publication No. 2014/0159869;

### U.S. Patent Application Publication No. 2014/0166759;

### U.S. Patent Application Publication No. 2014/0168787;

### U.S. Patent Application Publication No. 2014/0175165;

### U.S. Patent Application Publication No. 2014/0191684;

### U.S. Patent Application Publication No. 2014/0191913;

### U.S. Patent Application Publication No. 2014/0197304;

### U.S. Patent Application Publication No. 2014/0214631;

### U.S. Patent Application Publication No. 2014/0217166;

### U.S. Patent Application Publication No. 2014/0231500;

### U.S. Patent Application Publication No. 2014/0247315;

### U.S. Patent Application Publication No. 2014/0263493;

### U.S. Patent Application Publication No. 2014/0263645;

### U.S. Patent Application Publication No. 2014/0270196;

### U.S. Patent Application Publication No. 2014/0270229;

### U.S. Patent Application Publication No. 2014/0278387;

### U.S. Patent Application Publication No. 2014/0288933;

### U.S. Patent Application Publication No. 2014/0297058;

### U.S. Patent Application Publication No. 2014/0299665;

### U.S. Patent Application Publication No. 2014/0332590;

### U.S. Patent Application Publication No. 2014/0351317;

### U.S. Patent Application Publication No. 2014/0362184;

### U.S. Patent Application Publication No. 2014/0363015;

### U.S. Patent Application Publication No. 2014/0369511;

### U.S. Patent Application Publication No. 2014/0374483;

### U.S. Patent Application Publication No. 2014/0374485;

### U.S. Patent Application Publication No. 2015/0001301;

### U.S. Patent Application Publication No. 2015/0001304;

### U.S. Patent Application Publication No. 2015/0009338;

### U.S. Patent Application Publication No. 2015/0014416;

### U.S. Patent Application Publication No. 2015/0021397;

### U.S. Patent Application Publication No. 2015/0028104;

### U.S. Patent Application Publication No. 2015/0029002;

### U.S. Patent Application Publication No. 2015/0032709;

### U.S. Patent Application Publication No. 2015/0039309;

### U.S. Patent Application Publication No. 2015/0039878;

### U.S. Patent Application Publication No. 2015/0040378;

### U.S. Patent Application Publication No. 2015/0049347;

### U.S. Patent Application Publication No. 2015/0051992;

### U.S. Patent Application Publication No. 2015/0053769;

### U.S. Patent Application Publication No. 2015/0062366;

### U.S. Patent Application Publication No. 2015/0063215;

### U.S. Patent Application Publication No. 2015/0088522;

### U.S. Patent Application Publication No. 2015/0096872;

### U.S. Patent Application Publication No. 2015/0100196;

### U.S. Patent Application Publication No. 2015/0102109;

### U.S. Patent Application Publication No. 2015/0115035;

### U.S. Patent Application Publication No. 2015/0127791;

### U.S. Patent Application Publication No. 2015/0128116;

### U.S. Patent Application Publication No. 2015/0133047;

### U.S. Patent Application Publication No. 2015/0134470;

### U.S. Patent Application Publication No. 2015/0136851;

### U.S. Patent Application Publication No. 2015/0142492;

### U.S. Patent Application Publication No. 2015/0144692;

### U.S. Patent Application Publication No. 2015/0144698;

### U.S. Patent Application Publication No. 2015/0149946;

### U.S. Patent Application Publication No. 2015/0161429;

### U.S. Patent Application Publication No. 2015/0178523;

### U.S. Patent Application Publication No. 2015/0178537;

### U.S. Patent Application Publication No. 2015/0178685;

### U.S. Patent Application Publication No. 2015/0181109;

### U.S. Patent Application Publication No. 2015/0199957;

### U.S. Patent Application Publication No. 2015/0210199;

### U.S. Patent Application Publication No. 2015/0212565;

### U.S. Patent Application Publication No. 2015/0213647;

### U.S. Patent Application Publication No. 2015/0220753;

### U.S. Patent Application Publication No. 2015/0220901;

### U.S. Patent Application Publication No. 2015/0227189;

### U.S. Patent Application Publication No. 2015/0236984;

### U.S. Patent Application Publication No. 2015/0239348;

### U.S. Patent Application Publication No. 2015/0242658;

### U.S. Patent Application Publication No. 2015/0248572;

### U.S. Patent Application Publication No. 2015/0254485;

### U.S. Patent Application Publication No. 2015/0261643;

### U.S. Patent Application Publication No. 2015/0264624;

### U.S. Patent Application Publication No. 2015/0268971;

### U.S. Patent Application Publication No. 2015/0269402;

### U.S. Patent Application Publication No. 2015/0288689;

### U.S. Patent Application Publication No. 2015/0288896;

### U.S. Patent Application Publication No. 2015/0310243;

### U.S. Patent Application Publication No. 2015/0310244;

### U.S. Patent Application Publication No. 2015/0310389;

### U.S. Patent Application Publication No. 2015/0312780;

### U.S. Patent Application Publication No. 2015/0327012;

### U.S. Patent Application Publication No. 2016/0014251;

### U.S. Patent Application Publication No. 2016/0025697;

### U.S. Patent Application Publication No. 2016/0026838;

### U.S. Patent Application Publication No. 2016/0026839;

### U.S. Patent Application Publication No. 2016/0040982;

### U.S. Patent Application Publication No. 2016/0042241;

### U.S. Patent Application Publication No. 2016/0057230;

### U.S. Patent Application Publication No. 2016/0062473;

### U.S. Patent Application Publication No. 2016/0070944;

### U.S. Patent Application Publication No. 2016/0092805;

### U.S. Patent Application Publication No. 2016/0101936;

### U.S. Patent Application Publication No. 2016/0104019;

### U.S. Patent Application Publication No. 2016/0104274;

### U.S. Patent Application Publication No. 2016/0109219;

### U.S. Patent Application Publication No. 2016/0109220;

### U.S. Patent Application Publication No. 2016/0109224;

### U.S. Patent Application Publication No. 2016/0112631;

### U.S. Patent Application Publication No. 2016/0112643;

### U.S. Patent Application Publication No. 2016/0117627;

### U.S. Patent Application Publication No. 2016/0124516;

### U.S. Patent Application Publication No. 2016/0125217;

### U.S. Patent Application Publication No. 2016/0125342;

### U.S. Patent Application Publication No. 2016/0125873;

### U.S. Patent Application Publication No. 2016/0133253;

### U.S. Patent Application Publication No. 2016/0171597;

### U.S. Patent Application Publication No. 2016/0171666;

### U.S. Patent Application Publication No. 2016/0171720;

### U.S. Patent Application Publication No. 2016/0171775;

### U.S. Patent Application Publication No. 2016/0171777;

### U.S. Patent Application Publication No. 2016/0174674;

### U.S. Patent Application Publication No. 2016/0178479;

### U.S. Patent Application Publication No. 2016/0178685;

### U.S. Patent Application Publication No. 2016/0178707;

### U.S. Patent Application Publication No. 2016/0179132;

### U.S. Patent Application Publication No. 2016/0179143;

### U.S. Patent Application Publication No. 2016/0179368;

### U.S. Patent Application Publication No. 2016/0179378;

### U.S. Patent Application Publication No. 2016/0180130;

### U.S. Patent Application Publication No. 2016/0180133;

### U.S. Patent Application Publication No. 2016/0180136;

### U.S. Patent Application Publication No. 2016/0180594;

### U.S. Patent Application Publication No. 2016/0180663;

### U.S. Patent Application Publication No. 2016/0180678;

### U.S. Patent Application Publication No. 2016/0180713;

### U.S. Patent Application Publication No. 2016/0185136;

### U.S. Patent Application Publication No. 2016/0185291;

### U.S. Patent Application Publication No. 2016/0186926;

### U.S. Patent Application Publication No. 2016/0188861;

### U.S. Patent Application Publication No. 2016/0188939;

### U.S. Patent Application Publication No. 2016/0188940;

### U.S. Patent Application Publication No. 2016/0188941;

### U.S. Patent Application Publication No. 2016/0188942;

### U.S. Patent Application Publication No. 2016/0188943;

### U.S. Patent Application Publication No. 2016/0188944;

### U.S. Patent Application Publication No. 2016/0189076;

### U.S. Patent Application Publication No. 2016/0189087;

### U.S. Patent Application Publication No. 2016/0189088;

### U.S. Patent Application Publication No. 2016/0189092;

### U.S. Patent Application Publication No. 2016/0189284;

### U.S. Patent Application Publication No. 2016/0189288;

### U.S. Patent Application Publication No. 2016/0189366;

### U.S. Patent Application Publication No. 2016/0189443;

### U.S. Patent Application Publication No. 2016/0189447;

### U.S. Patent Application Publication No. 2016/0189489;

### U.S. Patent Application Publication No. 2016/0192051;

### U.S. Patent Application Publication No. 2016/0202951;

### U.S. Patent Application Publication No. 2016/0202958;

### U.S. Patent Application Publication No. 2016/0202959;

### U.S. Patent Application Publication No. 2016/0203021;

### U.S. Patent Application Publication No. 2016/0203429;

### U.S. Patent Application Publication No. 2016/0203797;

### U.S. Patent Application Publication No. 2016/0203820;

### U.S. Patent Application Publication No. 2016/0204623;

### U.S. Patent Application Publication No. 2016/0204636;

### U.S. Patent Application Publication No. 2016/0204638;

### U.S. Patent Application Publication No. 2016/0227912;

### U.S. Patent Application Publication No. 2016/0232891;

### U.S. Patent Application Publication No. 2016/0292477;

### U.S. Patent Application Publication No. 2016/0294779;

### U.S. Patent Application Publication No. 2016/0306769;

### U.S. Patent Application Publication No. 2016/0314276;

### U.S. Patent Application Publication No. 2016/0314294;

### U.S. Patent Application Publication No. 2016/0316190;

### U.S. Patent Application Publication No. 2016/0323310;

### U.S. Patent Application Publication No. 2016/0325677;

### U.S. Patent Application Publication No. 2016/0327614;

### U.S. Patent Application Publication No. 2016/0327930;

### U.S. Patent Application Publication No. 2016/0328762;

### U.S. Patent Application Publication No. 2016/0330218;

### U.S. Patent Application Publication No. 2016/0343163;

### U.S. Patent Application Publication No. 2016/0343176;

### U.S. Patent Application Publication No. 2016/0364914;

### U.S. Patent Application Publication No. 2016/0370220;

### U.S. Patent Application Publication No. 2016/0372282;

### U.S. Patent Application Publication No. 2016/0373847;

### U.S. Patent Application Publication No. 2016/0377414;

### U.S. Patent Application Publication No. 2016/0377417;

### U.S. Patent Application Publication No. 2017/0010141;

### U.S. Patent Application Publication No. 2017/0010328;

### U.S. Patent Application Publication No. 2017/0010780;

### U.S. Patent Application Publication No. 2017/0016714;

### U.S. Patent Application Publication No. 2017/0018094;

### U.S. Patent Application Publication No. 2017/0046603;

### U.S. Patent Application Publication No. 2017/0047864;

### U.S. Patent Application Publication No. 2017/0053146;

### U.S. Patent Application Publication No. 2017/0053147;

### U.S. Patent Application Publication No. 2017/0053647;

### U.S. Patent Application Publication No. 2017/0055606;

### U.S. Patent Application Publication No. 2017/0060316;

### U.S. Patent Application Publication No. 2017/0061961;

### U.S. Patent Application Publication No. 2017/0064634;

### U.S. Patent Application Publication No. 2017/0083730;

### U.S. Patent Application Publication No. 2017/0091502;

### U.S. Patent Application Publication No. 2017/0091706;

### U.S. Patent Application Publication No. 2017/0091741;

### U.S. Patent Application Publication No. 2017/0091904;

### U.S. Patent Application Publication No. 2017/0092908;

### U.S. Patent Application Publication No. 2017/0094238;

### U.S. Patent Application Publication No. 2017/0098947;

### U.S. Patent Application Publication No. 2017/0100949;

### U.S. Patent Application Publication No. 2017/0108838;

### U.S. Patent Application Publication No. 2017/0108895;

### U.S. Patent Application Publication No. 2017/0118355;

### U.S. Patent Application Publication No. 2017/0123598;

### U.S. Patent Application Publication No. 2017/0124369;

### U.S. Patent Application Publication No. 2017/0124396;

### U.S. Patent Application Publication No. 2017/0124687;

### U.S. Patent Application Publication No. 2017/0126873;

### U.S. Patent Application Publication No. 2017/0126904;

### U.S. Patent Application Publication No. 2017/0139012;

### U.S. Patent Application Publication No. 2017/0140329;

### U.S. Patent Application Publication No. 2017/0140731;

### U.S. Patent Application Publication No. 2017/0147847;

### U.S. Patent Application Publication No. 2017/0150124;

### U.S. Patent Application Publication No. 2017/0169198;

### U.S. Patent Application Publication No. 2017/0171035;

### U.S. Patent Application Publication No. 2017/0171703;

### U.S. Patent Application Publication No. 2017/0171803;

### U.S. Patent Application Publication No. 2017/0180359;

### U.S. Patent Application Publication No. 2017/0180577;

### U.S. Patent Application Publication No. 2017/0181299;

### U.S. Patent Application Publication No. 2017/0190192;

### U.S. Patent Application Publication No. 2017/0193432;

### U.S. Patent Application Publication No. 2017/0193461;

### U.S. Patent Application Publication No. 2017/0193727;

### U.S. Patent Application Publication No. 2017/0199266;

### U.S. Patent Application Publication No. 2017/0200108; and

### U.S. Patent Application Publication No. 2017/0200275.

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A device, comprising:
a modular print engine comprising a modular print head and a media encoder;
a printed circuit board (PCB) comprising a processor; and
a main body comprising the modular print engine and the printed circuit board;
wherein, the modular print engine is removable from the main body to allow a user to load a new ribbon in the modular print engine; and
wherein, when the modular print engine and a media are in contact and there is movement between the modular print engine and the media, the modular print engine prints on the media.

2. The device according to claim 1, wherein, when the device presses against the media, a burn line of the modular print head presses a ribbon against the media.

3. The device according to claim 1, wherein, in response to the device starting to slide across to the media, the media encoder sends a signal to the processor with an instruction to start a print operation.

4. The device according to claim 3, wherein, the media encoder generates the signal based on a rotation in the media encoder caused by the device sliding across the media.

5. The device according to claim 4, wherein the modular print engine comprises a rotating arm with a spring mechanism, associated with the media encoder.

6. The device according to claim 1, comprising a cover of the main body to allow for a removal of the modular print engine.

7. The device according to claim 1, wherein, based on a direction of rotation of the media encoder, the modular print engine either stops printing, or continues printing.

8. The device according to claim 1, comprising a fine needle opening located at one end of the device, wherein, when an adapter plug is inserted in the fine needle opening, silicon rubber of the adapter plug conforms to a shape of the adapter plug and creates a seamless water proofing seal between the adapter plug and the device.

9. The device according to claim 1, wherein, the main body comprises a battery.

10. The device according to claim 1, wherein, the modular print head is removable from the modular print engine.

11. A method, comprising the steps of:
opening, by a user, a cover from a main body of a printer;
removing, by the user, a modular print engine from a casing of the main body;
loading, by the user, a ribbon roll in the modular print engine;
inserting, by the user, the modular print engine in the casing of the main body; and
closing, by the user, the cover on the main body.

12. The method according to claim 11, wherein loading the ribbon roll in the modular print engine comprises installing a new ribbon on a ribbon supply shaft and removing an old ribbon from a ribbon rewind shaft.

13. The method according to claim 12, wherein a media encoder determines if the modular print engine is depleted of ribbon.

14. A method, comprising the steps of:
removing, by a user, a modular print engine from a main body of a printer;
loading, by the user, a ribbon roll into the modular print engine;
re-installing, by the user, the modular print engine in the main body of the printer positioning and pressing, by the user, a print head and a media encoder of the modular print engine on a media located on a horizontal surface; and
sliding, by the user, the print head across the media, causing the media encoder to sense a movement of the media relative to the print head and send a signal to a processor of the printer, wherein the processor sends an instruction to the print head to begin a print operation.

15. The method according to claim 14, comprising, if the user continues to slide the print head across the media, the print head continues the print operation.

16. The method according to claim 14, comprising, if the user does not continue to slide the print head across the media, the processor sends another instruction to the print head to stop the print operation.

17. The method according to claim 14, wherein removing the modular print engine from the main body of the printer comprises the user removing a cover from the modular print engine and removing the modular print engine from a casing of the main body of the printer.

18. The method according to claim 14, wherein, when the print head presses against the media, a burn line of the print head presses ribbon against the media.

19. The method according to claim 14, wherein the media encoder pulls ribbon past a burn line as the printer slides across the media.

20. The method according to claim 14, wherein the print head is removable from the modular print engine.
